(19) United States
(12) Patent Application Publication
(10) Pub. No.: US 2011/0060915 A1
(43) Pub. Date: Mar. 10, 2011

(54) Managing Encryption of Data

(75) Inventor: Sivan Tal, Yokneam Ilit (IL)

(73) Assignee: INTERNATIONAL BUSINESS MACHINES CORPORATION, Armonk, NY (US)

(21) Appl. No.: 12/557,027

(22) Filed: Sep. 10, 2009

(51) Int. Cl. G06F 12/14; G06F 12/00

(52) U.S. Cl. 713/189; 711/154; 711/E12.001

(57) ABSTRACT

In an illustrative embodiment, a method, computer program product, and apparatus for managing encryption of data are provided. The method comprises determining whether the number of data units contains a known pattern responsive to receiving a number of data units to write to a storage device; storing the number of data units on the storage device in an unencrypted form responsive to a determination that the number of data units contains the known pattern; encrypting the number of data units to form encrypted data units responsive to an absence of a determination that the data contains the known pattern; and storing the encrypted data units on the storage device.

### BACKGROUND

1. Field

The disclosure relates generally to an improved data processing system and more specifically to a method, computer program product, and apparatus for managing encryption of data.

2. Description of the Related Art

Within data processing systems, data is often encrypted to prevent unauthorized access to the data. Data encryption secures data by transforming the data using an algorithm. The algorithm transforms the data into a form that is unreadable until the data is decrypted. Some examples of encryption algorithms are Advanced Encryption Standard (AES), Data Encryption Standard (DES), Blowfish, International Data Encryption Algorithm (IDEA), and RC4. To decrypt the data, the encrypted data is transformed by a decryption algorithm using an access device. The access device may be one or more of a password, key file, personal identification number (PIN), hardware token, software token, or any other suitable access device. Once transformed, the decrypted data is the same as the original data.

Data is often encrypted at the disk level because data on a disk is vulnerable to unauthorized access. For example, when a computer is turned off, data remains stored on a variety of disks. Hard disk drives are an example of disks on which data remains stored when the computer is turned off. An unauthorized user may connect the hard disk drive to a different computer. The data may then be accessible to the unauthorized user.

Some operating systems provide disk encryption and disk decryption features. Whenever the operating system requests that data be written to disk, the disk encryption feature encrypts the data prior to storing the data on a disk. When the data is loaded from the disk by the operating system, a disk decryption feature decrypts the data. The disk decryption feature then provides the decrypted data to the operating system. One such disk encryption and disk decryption features is BitLocker® from Microsoft Corporation in Redmond, Wash.

### SUMMARY

The illustrative embodiments provide a method, computer program product, and apparatus for managing encryption of data. A determination is made whether the number of data units contains a known pattern responsive to receiving a number of data units to write to a storage device. The number of data units are stored on the storage device in an unencrypted form in response to a determination that the number of data units contains the known pattern. The number of data units are encrypted to form encrypted data units in response to an absence of a determination that the number of data units contains the known pattern. The encrypted data units are then stored on the storage device.

### BRIEF DESCRIPTION OF THE SEVERAL VIEWS OF THE DRAWINGS

FIG. 1 depicts a block diagram of a network of data processing systems in which illustrative embodiments may be implemented;

FIG. 2 depicts a block diagram of a data processing system in accordance with an illustrative embodiment;

FIG. 3 depicts a block diagram of an encryption manager executing in a data processing system;

FIG. 4 depicts a block diagram of a storage device in accordance with an illustrative embodiment;

FIG. 5 depicts a table representing metadata stored on a storage device in accordance with an illustrative embodiment;

FIG. 6 depicts a table representing encryption policies for data stored in units of a storage device in accordance with an illustrative embodiment;

FIG. 7 depicts a state diagram of the encryption status of a unit of data on a storage device in accordance with an illustrative embodiment;

FIG. 8 depicts a flowchart of a process for managing encryption of data in accordance with an illustrative embodiment;

FIG. 9 depicts a process for storing a number of data units on the storage device in the unencrypted form in accordance with an illustrative embodiment;

FIG. 10 depicts a process for storing encrypted data on the storage device in accordance with an illustrative embodiment;

FIG. 11 depicts a process for initializing a number of blocks on a storage device in accordance with an illustrative embodiment; and

FIGS. 12 and 13 depict a process for handling a request issued by the operating system in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

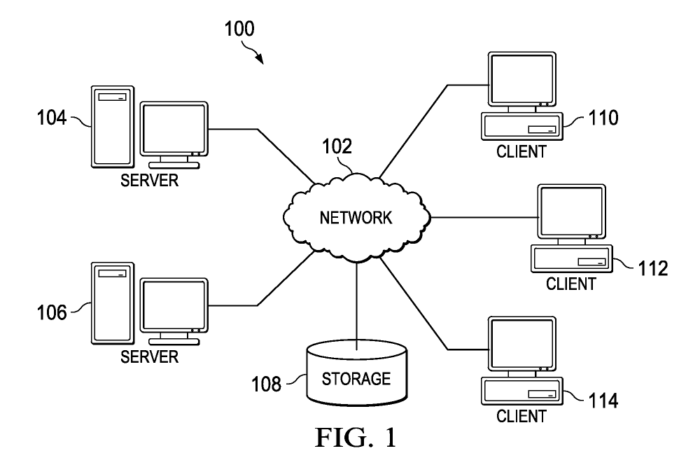

Turning now to FIG. 1, a block diagram of a network of data processing systems in which illustrative embodiments may be implemented is depicted. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server computer 104 and server computer 106 connect to network 102. In addition, client computers 108, 110, and 112 connect to network 102. Storage unit 114 may also connect to network 102. Client computers 108, 110, and 112 may be, for example, personal computers or network computers. In the depicted example, server computer 104 provides data, such as boot files, operating system images, applications, documents, photos, or any other suitable data to client computers 108, 110, and 112. Client computers 108, 110, and 112 are clients to server computer 104 in this example. Network data processing system 100 may include additional server computers, client computers, and other devices not shown. An encryption manager may be implemented in network data processing system 100 by executing on one or more of server computer 104, server computer 106, client computer 108, client computer 110, and client computer 112. Alternatively, server computer 104 and client computer 108 may instead be located within the same physical machine.

Illustrative embodiments may be implemented within any one or more of server computers 104 and 106 and client computers 108, 110, and 112. The one or more server computers 104 and 106 and client computers 108, 110, and 112 may run an encryption manager to protect data stored on storage devices. The data protected by the encryption manager may be located in the same computer or a different computer than the computer running the encryption manager. Alternatively, the data protected by the encryption manager may be located in storage unit 108, while the encryption manager runs on a computer, such as server computer 104, server computer 106, client computer 108, client computer 110, or client computer 112.

Program code located in network data processing system 100 may be stored on a computer recordable storage medium and downloaded to a data processing system or other device for use. For example, program code may be stored on a computer recordable storage medium on server computer 104 and downloaded to client computer 108 over network 102 for use on client computer 108.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example and not as an architectural limitation for the different illustrative embodiments.

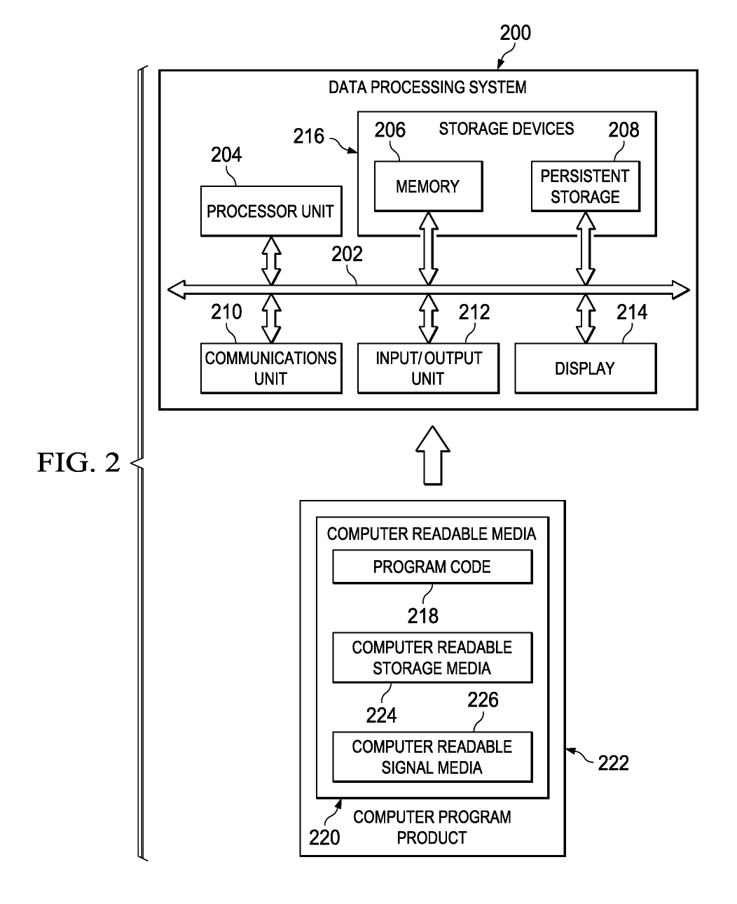

Turning now to FIG. 2, a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The different illustrative embodiments recognize and take into account a number of different considerations. For example, the different illustrative embodiments recognize that data stored on disks is vulnerable to access by unauthorized parties. In the case of encryption over the entire disk, the data may still be vulnerable to unauthorized access by an attacker. The different illustrative embodiments recognize that attackers may attempt to determine a valid decryption key for encrypted data.

One method used by attackers seeking access to the encrypted data is to analyze the encrypted data for weaknesses that could expose parts of a valid decryption key. An attacker may examine encrypted data on portions of the disk known to be used for operating system data. In this illustrative example, operating system data is data that is stored by the operating system and not generated by the user. Examples of operating system data are cache files, dynamic link libraries, executables, and disk initialization data. Some operating system data may be identical or nearly identical on a number of computers running the operating system. Additionally, the location of some operating system data on the disk may be identical or nearly identical on a number of computers running the operating system.

The different illustrative embodiments recognize that an attacker may assume the approximate content and location of operating system data on the encrypted disk based on the operating system known to be installed on the encrypted disk. The attacker may then compare the encrypted data at the assumed location and the unencrypted operating system data from a number of other computers running the operating system. Once the attacker compares the data, the illustrative embodiments recognize that the attacker may determine a valid decryption key or a portion of a valid decryption key.

Thus, the illustrative embodiments provide a method, apparatus, and computer program product for managing encryption of data. The illustrative embodiments protect encrypted data by detecting patterns of data commonly known to attackers and storing the patterns in an unencrypted form. Attackers cannot combine the unencrypted form of commonly known patterns with the encrypted form of the commonly known patterns of data to determine a valid decryption key or a portion of a valid decryption key because the commonly known patterns of data are not encrypted on the storage device. In addition to detecting the commonly known patterns, the illustrative embodiments allow the operating system to specify whether particular units of data should be stored in unencrypted form or encrypted form. The illustrative embodiments also manage the status of units of data on the storage device by storing a status for each unit in metadata on the storage device.

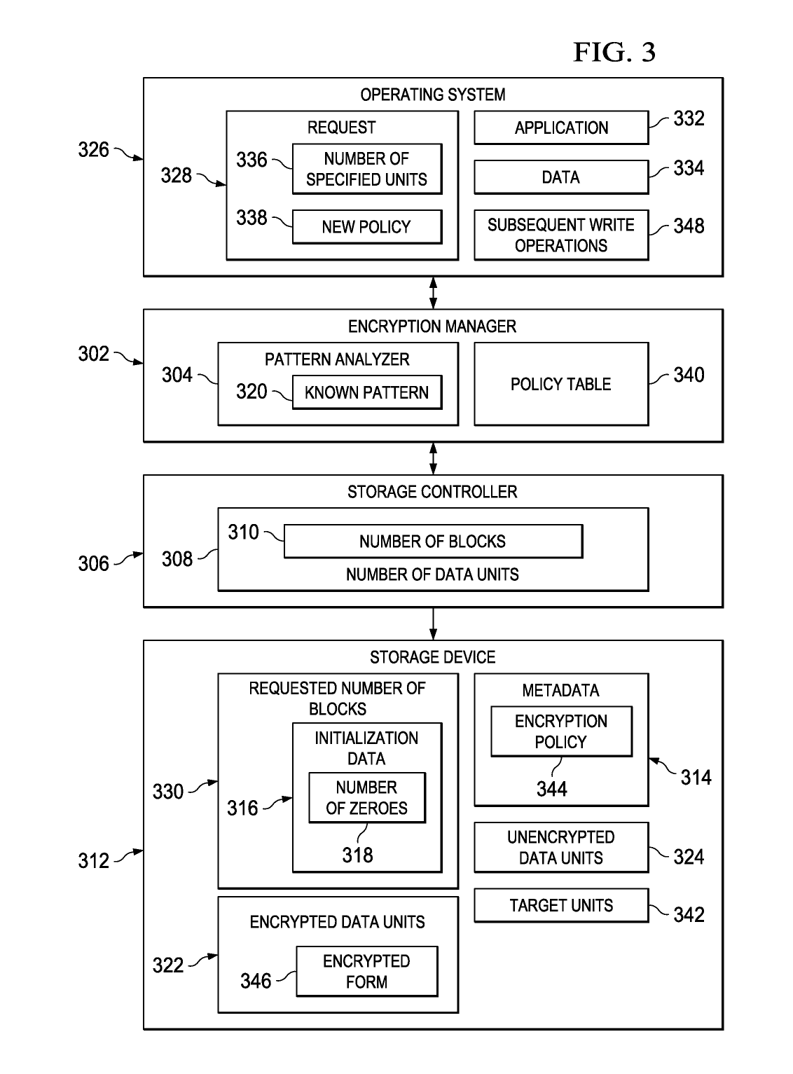

Turning now to FIG. 3, a block diagram of an encryption manager executing in a data processing system is depicted. Data processing system 300 may be a data processing system, such as data processing system 200 in FIG. 2. Data processing system 300 executes encryption manager 302 and operating system 326. Operating system 326 communicates with encryption manager 302. In one illustrative embodiment, an application programming interface is present within operating system 326 to allow both operating system 326 and applications executing within operating system 326 to communicate with encryption manager 302.

Encryption manager 302 contains pattern analyzer 304. Pattern analyzer 304 examines the contents of which data operating system 326 has sent to storage controller 306 for storage on storage device 312. Pattern analyzer 304 stores one or more known patterns 320. Known pattern 320 may be operating system data. Operating system data is data stored by the operating system that is not generated by a user. Data 334 generated by a user is generated by input from a user using an input device. In illustrative embodiments, the input device is a keyboard, a mouse, an optical scanning device, a magnetic strip, a smart card, and/or another suitable input device. Examples of operating system data are cache files, dynamic link libraries, executables, and disk initialization data. Illustrative examples of data 334 are one or more spreadsheets, text files, emails, images, presentation files, and databases created and/or edited by a user. Data 334 is stored in the form of number of data units 308.

In some illustrative embodiments, data 334 also includes data generated by an application 332 based on user input. A user may request that application 332 generate data 334 based on a user input. Application 332 may cause data 334 to be generated based on the user input and stored on storage device 312. For example, a user may input an arithmetic operation into a calculator application and request the result be stored on storage device 312. In this example, data 334 is the result of the arithmetic operation generated by the calculator application based on the user input.

In these illustrative embodiments, data 334 may be generated, based on a user input, by application 332 running on data processing system 300. However, data 334 may be generated, based on a user request, by an application running one or more other computers. A response to the user request may be received by data processing system 300 over a network, such as network 102 in FIG. 1. In these illustrative embodiments, data responsive to the user request that is stored by operating system 326 is data 334.

For example, a user inputs an arithmetic operation into a Web-based calculator application running on a remote computer. The user requests that the result of the arithmetic operation be returned from the remote computer and stored on storage device 312. The remote computer computes the result of the arithmetic operation and uses the network to send the result to operating system 326. Operating system 326 receives the result and the result is sent to encryption manager 302 as data 334. It should be appreciated that the data returned by an application running on a remote computer may be any suitable data, including but not limited to, one or more spreadsheets, text files, emails, images, presentation files, and databases.

Pattern analyzer 304 examines the contents of number of data units 308 as number of data units 308 is transferred between operating system 326 and storage controller 306. Number of data units 308 may be, in some illustrative examples, number of blocks 310. A block may be a division of the physical media on storage device 312 in which units of data may be stored.

Encryption manager 302 then determines the target units 342 on storage device 312. Target units 342 are the units on storage device 312 selected by storage controller 312 to store number of data units 308. Encryption manager may request metadata 314 associated with target units 342 from storage controller 306. Encryption manager may locate encryption policy 344 in metadata 314 associated with target units 342. More than one encryption policy 344 may apply to target units 342. If encryption policy 344 indicates that data stored in target units 342 may be encrypted if the data contains a known pattern 320, pattern analyzer 304 compares the content of number of data units 308 to known patterns 320. Based on the comparison of number of data units 308 with known patterns 320, pattern analyzer 304 determines whether number of data units 308 contains a known pattern 320.

Known pattern 320 is a pattern of data that is vulnerable to attack by an attacker. Known pattern 320 may be a pattern of data that is found in an identical or similar form on storage devices other than storage device 312 that contain an installation of operating system 326 or a similar operating system. Known pattern 320 may also be stored in an identical or similar location on storage devices other than storage device 312 that contain an installation of operating system 326 or a similar operating system. Known pattern 320, when encrypted and stored on storage device 312, is compared with an unencrypted form of the same pattern of data by an attacker. The attacker may have learned of the unencrypted form of the pattern of data from an unencrypted storage device containing the same or a similar operating system. The attacker uses the comparison to determine at least a portion of a valid decryption key for other encrypted data on the storage device.

In one illustrative example, known pattern 320 is a portion of a configuration file for operating system 326. The configuration file may be the same in multiple installations of operating system 326. The configuration file may also be stored in the same or similar location on storage device 312 in multiple installations of operating system 326. In this example, the attacker extracts known pattern 320 and the location of known pattern 320 on a storage device without encryption in a second data processing system 300. The attacker then compares the data at the same location on storage device 312 to the known pattern 320 extracted from the second data processing system 300. The attacker may then be able to use the results of the comparison to determine characteristics of a valid decryption key, a portion of a valid decryption key and/or a valid decryption key for other encrypted data units 322.

Characteristics of a valid decryption key may include, for example, the length of a valid decryption key, a set of characters present in a valid decryption key, a set of characters not present in a valid decryption key, or any other suitable characteristics. The determination of such characteristics about the decryption key by an attacker reduces the strength of the encryption solution because knowledge of one or more characteristics of a valid decryption key reduces the number of possible decryption keys. An attacker may then attempt to try all remaining possible decryption keys until a valid decryption key is found.

If encryption policy 344 associated with target units 342 indicates that number of data units is to be always encrypted or never encrypted, encryption manager may send data to storage controller 306 without running pattern analyzer 304.

Storage controller 306 is present in data processing system 300. Storage controller 306 communicates with storage device 312. Storage device 312 may be a storage device, such as storage device 216 in FIG. 2. In an illustrative embodiment, storage device 312 is a hard disk drive. Storage controller 306 receives number of data units 308 from encryption manager 302. In other illustrative embodiments, encryption manager 302 executes within storage controller 306. In such illustrative embodiments, storage controller 306 receives number of data units 308 from operating system 326.

If pattern analyzer 304 detected a known pattern 320 in number of data units 308, encryption manager 302 causes storage controller 306 to store number of data units 308 on storage device 312 in an unencrypted form as unencrypted data units 324. Encryption manager 302 then edits metadata 314 on storage device 312. Metadata 314 is associated with one or more units of storage device 312. For example, metadata 314 may contain one or more block identifiers for the one or more blocks to which metadata 314 applies.

Encryption manager 302 sets metadata 314 associated with unencrypted data units 324 to indicate that the data in unencrypted data units 324 is unencrypted. In other illustrative embodiments, metadata 314 is stored in a database that may be located on storage device 312 or a storage device in another data processing system 300.

If pattern analyzer 304 did not detect a known pattern 320 in number of data units 308, encryption manager 302 encrypts number of data units 308. Encryption manager may use any suitable encryption algorithm to encrypt number of data units 308. Illustrative examples of encryption algorithms are Data Encryption Standard (DES), Blowfish, International Data Encryption Algorithm (IDEA), and RC4. After encrypting number of data units 308, encryption manager 302 causes storage controller 306 to store encrypted data units on storage device 312 as encrypted data units 322. Encryption manager 302 then stores metadata 314. Metadata 314 contains the location of encrypted data units 322 on storage device 312 and an indication that encrypted data units 322 are encrypted.

In some illustrative embodiments, metadata 314 also contains encryption policy 344. Encryption policy 344 indicates an action to take with regard to data to be stored in the units of storage device 312 associated with metadata 314. For example, encryption policy 344 may be a policy to always encrypt the data, never encrypt the data, conditionally encrypt the data, or any other suitable policy. If encryption policy 344 is a policy to conditionally encrypt the data, the condition may be whether the data contains known pattern 320 or any other suitable condition. In some illustrative embodiments, encryption policy 344 contains one or more policies. In another illustrative embodiment, encryption policy 344 contains a link to a policy that is stored in another data structure, such as policy table 340, a database, or another suitable data structure.

In these illustrative embodiments, encryption manager 302 requests target units 342, prior to determining whether number of data units 308 contains known pattern 320. Target units 342 are the units of storage device 312 that will store number of data units 308. Target units 342 may be selected by storage controller 306. The selection of target units 342 may be based on the location of free space on storage device 312 or an algorithm that stores data likely to be used together in close proximity on storage device 312. Of course, any suitable algorithm may be used for determining target units 342.

In an illustrative embodiment, storage device 312 responds by providing unit identifiers of target units 342. Encryption manager 302 then reads encryption policy 344 associated with target units 342. Encryption manager may request encryption policy 344 from storage controller 306.

If encryption policy 344 in metadata 314 associated with target units 342 indicates to “conditionally encrypt”, encryption manager may use pattern analyzer 304 to determine whether number of data units 308 contains known pattern 320. If number of data units 308 contains known pattern 320, encryption manager 302 causes storage controller 306 to store number of data units 308 as unencrypted data units 324. If number of data units 308 does not contain known pattern 320, encryption manager 302 encrypts number of data units 308 to form encrypted data units 322 and causes storage controller 306 to store encrypted data units 322 in target units 342 on storage device 312.

If encryption policy 344 indicates to “always encrypt”, encryption manager 302 encrypts number of data units 308 to form encrypted data units 322 and causes storage controller 306 to store encrypted data units 322 in target units 342 on storage device 312. If encryption policy 344 indicates to “never encrypt”, encryption manager 302 causes storage controller 306 to store number of data units 308 as unencrypted data units 324 in target units 342 on storage device 312.

Once encrypted data units 322 and/or unencrypted data units 324 have been stored on storage device 312, operating system 326 may request encrypted data units 322 and/or unencrypted data units 324 from storage controller 306. For example, the request from operating system 326 may be a read operation. Storage controller 306 uses metadata 314 to determine whether the data requested by operating system 326 is encrypted data units 322 or unencrypted data units 324. If the data requested by operating system 326 is encrypted data units 322, encryption manager 302 decrypts encrypted data units 322 before returning the requested data to operating system 326. If the data requested by operating system 326 is unencrypted data units 324, encryption manager 302 returns the requested data to operating system 326.

In some illustrative embodiments, operating system 326 initializes units of storage device 312. In one example, operating system 326 initializes units of storage device 312 at a point in time after the units have been allocated by storage controller 306. Storage controller 306 allocates units of storage device 312 by making the units of storage available to operating system 326. For example, storage controller 306 may create a partition on storage device 312 to store data. Initializing units of storage device 312 transforms a number of portions of storage device 312 into a format that is known by the operating system. In one illustrative example, operating system 326 initializes a requested number of blocks 330 on storage device 312 by sending request 328 to storage controller 306. Request 328 may specify a requested number of blocks 330 to initialize. The requested number of blocks 330 may be specified by a user or determined based on an amount of space required by the operating system to perform an action. In the illustrative example, storage controller 306 allocates requested number of blocks 330 on storage device 312. Then, operating system 326 may specify initialization data 316 for storage controller 306 to write to requested number of blocks 330 in request 328. Initialization data 316 may be specified by operating system 326 in number of data units 308. In some illustrative embodiments, initialization data 316 is number of zeroes 318.

Operating system 326 initializes a requested number of blocks 330 on storage device 312 by sending a request to encryption manager 302. Encryption manager 302 causes pattern analyzer 304 to examine number of data units 308 and determine that number of data units 308 contains initialization data 316. Encryption manager 302 then causes storage controller 306 to store initialization data 316 as unencrypted data units 324. Encryption manager 302 then causes storage controller 306 to edit metadata 314 associated with unencrypted data units 324 on storage device 312. Encryption manager 302 may edit metadata 314 to indicate that initialization data 316 is unencrypted. In some illustrative embodiments, encryption manager also updates encryption policy 344 to a policy indicating that data written to unencrypted data units 324 in a subsequent write operation 348 is to be encrypted unless the data in the subsequent write operation 348 contains known pattern 320.

In another illustrative embodiment, request 328 is a request by operating system 326 and/or application 332 to encrypt target units 342 and edit encryption policy 344 to a policy indicating that data stored in target units 342 is to always be encrypted. Operating system 326 may send number of specified units 336 to encryption manager 302 with request 328. Number of specified units 336 specifies target units 342 on storage device 312 to encrypt. For example, number of specified units 336 may be a number of identifiers of blocks on storage device 312. Request 328 may also contain new policy 338. New policy 338 is an encryption policy that replaces encryption policy 344 in metadata 314 associated with target units 342. In this example, new policy 338 is an “always encrypt” policy. For example, application 332 running within operating system 326 may cause target units 342 stored on storage device 312 to be retrieved, encrypted, and stored in target units 322 in encrypted form 346. Encryption policy 344 in metadata 314 associated with target units 342 may also be updated to an “always encrypt” policy. Additionally, in some illustrative embodiments, application 332 causes number of data units 308 sent by application 332 for storage on storage device 312 that contain known pattern 320 to be encrypted prior to storage on storage device 312. In such embodiments, encryption policy 344 may also be updated to an “always encrypt” policy. For example, application 332 may issue request 328 for target units 342 that are known by application 332 not to contain known pattern 320. In an illustrative embodiment, performance of data processing system 300 is improved because pattern analyzer 304 does not determine whether number of data units 308 contains known pattern 320 when encryption policy 344 in metadata 314 associated with target units 342 is “always encrypt.”

In another illustrative embodiment, application 332 causes number of data units 308 to be stored on storage device 312 in an unencrypted form, regardless of whether number of data units 308 contains known pattern 320. For example, pattern analyzer 304 may not contain a pattern that became commonly known to attackers at a point in time after the creation of pattern analyzer 304. In this example, application 332 may specify that number of data units 308 should not be encrypted by encryption manager 302 prior to storage on storage device 312. Instead, number of data units 308 should be stored as unencrypted data units 324. Application 332 may also specify that encryption policy 344 in metadata 314 associated with unencrypted data units 324 be updated to an encryption policy 344 of “never encrypt.”

Of course, it should be appreciated that pattern analyzer 304 may be updated to include additional known patterns 320. For example, operating system 326 may periodically send a number of known patterns 320 to encryption manager 320 as an update to encryption manager 320.

In another illustrative embodiment, it is desirable for application 332 to cause particular target units 342 on storage device 312 to be stored in unencrypted form. For example, application 332 may be updated to a newer version. The newer version may contain additional known patterns 320 that were not present in the previous version application 332. Application 332 may locate target units 342 on storage device 312 that contain one or more known patterns 320.

Application 332 may cause the data stored in target units 342 on storage device 312 to be stored in unencrypted form by sending request 328 to encryption manager 302. Request 328 may contain number of specified units 336 and new policy 338. Number of specified units specifies target units 342 on storage device 312 to decrypt. For example, number of specified units 336 may be a number of identifiers of blocks on storage device 312. Encryption manager 302 then uses number of specified units 336 to identify target units 342 on storage device 312 to decrypt. Encryption manager 302 retrieves the data in target units 342 and decrypts the data to form unencrypted data units 324. Encryption manager 302 then causes storage controller 306 to store unencrypted data units 324 in target units 342. Encryption manager 302 may then update encryption policy 344 in metadata 314 associated with target units 342 to be updated to new policy 338. In this example, encryption policy is updated to a “never encrypt” policy.

The illustration of data processing system 300 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some illustrative embodiments, encryption manager 302 runs within storage controller 306. Encryption manager 302 may run on a processor within storage controller 306 or specialized circuitry. Encryption manager 302 may also be located in a separate data processing system 300. Encryption manager 302 may communicate with additional storage controllers 306. Storage controller 306 may communicate with more than one storage device 312. Initialization data 316 may be comprised of any suitable pattern that is recognizable by operating system 326. Additionally, encrypted data units 322 and unencrypted data units 324 may overwrite existing data on storage device 312. For example, if operating system 326 requests the deletion of particular unencrypted data units 324, storage controller 306 may later store encrypted data units 322 or other unencrypted data units 324 in the same location on storage device 312.

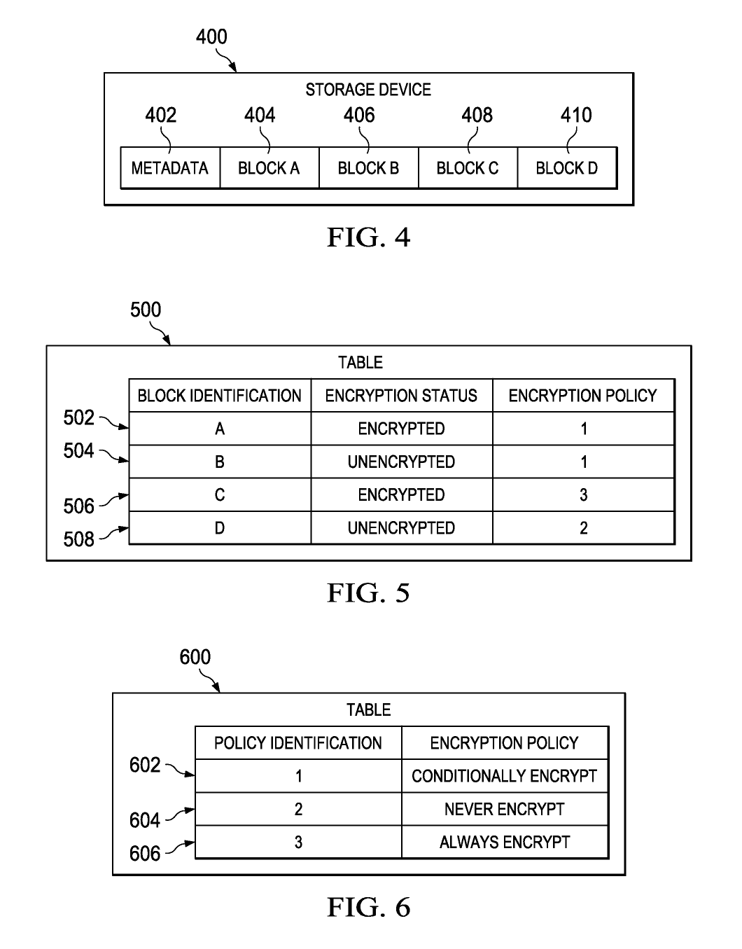

Turning now to FIG. 4, a block diagram of a storage device is depicted in accordance with an illustrative embodiment. Storage device 400 may be a storage device, such as storage device 312 from FIG. 3. Metadata 402 may be an implementation of metadata 314 from FIG. 3.

Storage device 400 contains metadata 402, block A 404, block B 406, block C 408, and block D 410. It will be appreciated that storage device 400 may contain any suitable number of blocks.

Turning now to FIG. 5, a table representing metadata stored on a storage device is depicted in accordance with an illustrative embodiment. Table 500 represents the contents of metadata 402 from FIG. 4. Of course, table 500 is only an example of data contained in metadata 402. Table 500 may have more or fewer rows.

Table 500 contains a listing of block IDs, encryption status, and encryption policies. Block ID represents the identification of blocks on storage device 400 of FIG. 4. However, block ID may be any suitable indicator for the location of a particular unit on storage device 400. Encryption status represents the status of encryption for the data at the corresponding block ID in table 500. Encryption policy contains an identifier of an encryption policy in a policy table that applies to the corresponding block ID. The policy table may be a policy table such as policy table 600 in FIG. 6. In another illustrative embodiment, encryption policy in table 500 contains the encryption policy that applies to the block ID of the row containing the encryption policy in table 500. In some illustrative examples, encryption policy may be set and/or updated by an application, such as application 332 from FIG. 3 that sends a request to an encryption manager, such as encryption manager 302 from FIG. 3.

Row 502 represents the encryption status of block A 404. Row 502 indicates that block A 404 is encrypted. Because block A 404 is encrypted, decryption will be necessary if the operating system requests the data in block A 404. The decryption may be performed by a storage controller, such as storage controller 306, an encryption manager, such as encryption manager 302, an operating system, such as operating system 326, or any other suitable decryption provider. Row 502 also indicates that policy 1 in table 600 is enforced on block A 404.

Row 504 represents the encryption status of block B 406. Row 504 indicates that block B 406 is unencrypted. Row 504 also indicates that policy 1 in table 600 is enforced on block B 406. Because block B 406 is unencrypted, no decryption will be necessary if the operating system requests the data in block B 406.

Row 506 represents the encryption status of block C 408. Row 506 indicates that block C 408 is encrypted. Because block C 408 is encrypted, decryption will be necessary if the operating system requests the data in block C 408. The decryption may be performed by a storage controller, such as storage controller 306, an encryption manager, such as encryption manager 302, an operating system, such as operating system 326, or any other suitable decryption provider. Row 506 also indicates that policy 3 in table 600 is enforced on block C 408.

Row 508 represents the encryption status of block D 410. Row 508 indicates that block D 410 is unencrypted. Row 508 also indicates that policy 2 in table 600 is enforced on block D 410. Because block D 410 is unencrypted, no decryption will be necessary if the operating system requests the data in block D 410.

Turning now to FIG. 6, a table representing encryption policies for data stored in units of a storage device is depicted in accordance with an illustrative embodiment. Table 600 represents the encryption policies of an encryption manager, such as encryption manager 302 from FIG. 3. Table 600 may be stored on storage device 400. For example, table 600 may be stored in metadata 402. Alternatively, table 600 may be stored in a database or another storage device, in the same data processing system or another data processing system. Table 600 may also be stored in memory, such as memory 206 or on any other suitable storage device.

Row 602 represents a policy with a policy ID of 1 and a policy of “conditionally encrypt”. An encryption manager reads metadata 402 to determine the encryption policy to enforce for the one or more blocks that will contain the data on storage device 400. When the encryption manager reads metadata 402 for a block that has a policy ID of 1, the encryption manager will encrypt the data prior to storing the data in the block, unless the data contains a known pattern, such as known pattern 320 from FIG. 3. For example, row 502 indicates that block A 404 has a policy ID of 1. Policy ID 1 is represented by row 602 in table 600. The policy in row 602 is to “conditionally encrypt”. Therefore, encryption manager 302 will use a pattern analyzer, such as pattern analyzer 304 to locate any known patterns within the data to be stored in block A 404. If the data contains a known pattern, the data is stored in block A 404 in unencrypted form. If the data does not contain a known pattern, the data is encrypted and stored in block A 404 in encrypted form.

For example, block A 404 is represented in metadata 402 by row 502. Row 502 indicates that block A 404 has an encryption policy with policy ID 1. Row 602 indicates that the encryption policy with policy ID 1 is to “conditionally encrypt”. In this example, the data to be stored in block A 404 does not contain a known pattern. Therefore, the data to be stored in block A 404 is encrypted and then stored in block A 404.

In another illustrative example, block B 406 is represented in metadata 402 by row 504. Row 504 indicates that block B 406 also has an encryption policy with policy ID 1. Row 602 indicates that the encryption policy with policy ID 1 is to “conditionally encrypt”. In this example, the data to be stored in block B 406 does contain a known pattern. The data to be stored in block B 406 is stored in block B 406 in unencrypted form.

Row 604 represents a policy with a policy ID of 2 and a policy of “never encrypt”. When the encryption manager reads metadata 402 for a block that has a policy ID of 2, the encryption manager will store the data on storage device 400 in unencrypted form, regardless of whether the data contains a known pattern.

Row 606 represents a policy with a policy ID of 2 and a policy of “always encrypt”. When the encryption manager reads metadata 402 for a block that has a policy ID of 3, the encryption manager will encrypt the data and store the encrypted data on storage device 400, regardless of whether the data contains a known pattern.

The illustration of storage device 400, table 500, and table 600 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, storage device 400 may contain more or fewer blocks than depicted in FIG. 4. Metadata 402 may be stored partially or totally in any suitable location on storage device 400. Alternatively, metadata 402 may be stored in another storage device, a database, or another data processing system. Table 500 may contain additional parameters for encryption, such as a length of time a particular policy is to remain in effect. Table 600 may contain more policies or fewer policies. The data in table 600 may be stored in one or more locations on storage device 400, another storage device, or another data processing system. Additionally, in some illustrative embodiments, one or more encryption policies are stored in table 500 for a particular block ID instead of a policy ID.

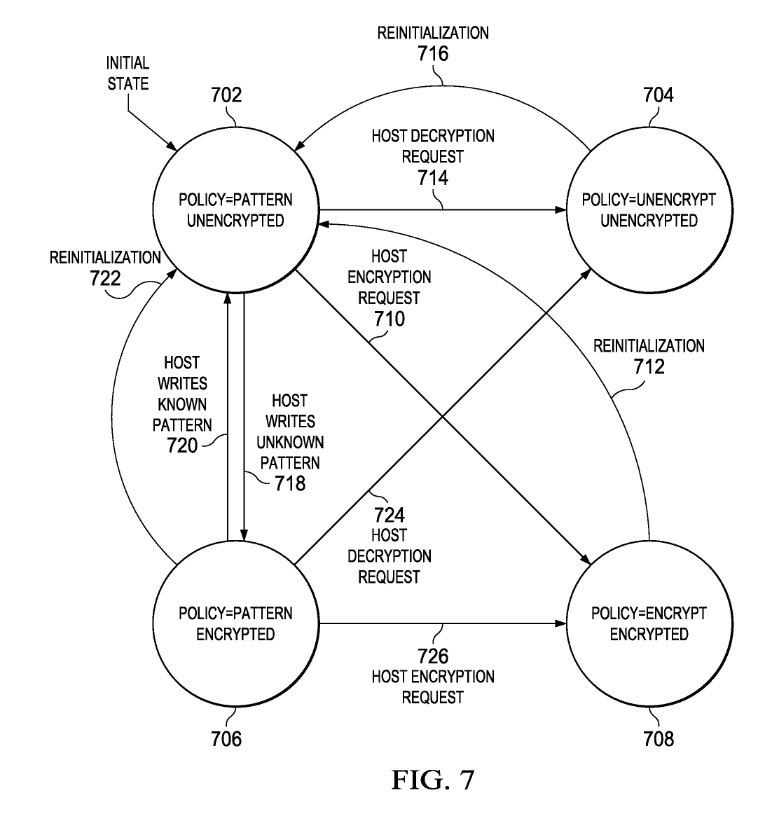

Turning now to FIG. 7, a state diagram of the encryption status of a unit of data on a storage device is depicted in accordance with an illustrative embodiment. State diagram 700 may be the state of a number of blocks stored on a storage device, such as storage device 312. The storage device may be in a data processing system, such as data processing system 300. One or more indications of state 702, state 704, state 706, and state 708 may be stored in metadata, such as metadata 314.

In one illustrative embodiment, state 702 is the initial state for blocks on the storage device. State 702 represents a state in which the data in the blocks is unencrypted and the encryption policy is to “conditionally encrypt”. In these illustrative examples, a policy to “conditionally encrypt” indicates that data stored in the blocks should be encrypted unless the data contains a known pattern, such as known pattern 320 in FIG. 3. The number of the blocks may enter the initial state 702 when the number of blocks are allocated by a storage controller, such as storage controller 306. Storage controller 306 may allocate the number of blocks based on a request from the operating system. The number of blocks may then be initialized by a request of the operating system. The number of blocks may then contain initialization data, such as initialization data 316.

The operating system may issue a request to encrypt a number of blocks stored on the storage device and/or implement an encryption policy of “always encrypt”. The state follows path 710 to state 708. An encryption manager encrypts the data in the number of blocks and causes the storage controller to store the encrypted data back to the number of blocks. The encryption manager also updates metadata associated with the number of blocks to indicate that the status of the data in the blocks is encrypted and the encryption policy is to “always encrypt”. In some illustrative embodiments, the encryption manager updates the encryption policy in the metadata by storing a policy identifier in the metadata. The policy identifier may be representative of a policy stored in a policy table, such as policy table 600 from FIG. 6.

State 708 represents a state in which the data in the blocks is encrypted and the encryption policy is to “always encrypt”, regardless of whether a known pattern is contained in the data in the blocks. The operating system may reinitialize the number of blocks to follow path 712 back to state 702. Reinitializing the number of blocks clears the data in the blocks and returns to the initial state 702 with a policy of “conditionally encrypt” and the data in the blocks is unencrypted.

From state 702, the operating system may issue a request to decrypt a number of blocks stored on the storage device and/or to implement an encryption policy of “never encrypt” for the blocks. The state follows path 714 to state 704. The encryption manager updates metadata associated with the number of blocks to indicate that the encryption policy is to “never encrypt”. State 704 represents a state in which the data in the blocks is unencrypted and the encryption policy is to “never encrypt”, regardless of whether a known pattern is contained in the data in the blocks. The operating system may reinitialize the number of blocks to follow path 716 back to state 702.

From state 702, the operating system may request to store data in the number of blocks. A pattern analyzer compares the data to known patterns, and determines that the data does not contain a known pattern. The state follows path 718 to state 706. State 706 represents a state in which the data in the blocks is encrypted, and the encryption policy is to “conditionally encrypt”. From state 706, the operating system may reinitialize the number of blocks and follow path 722 back to state 702.

From state 706, the operating system may also request to store data in the number of blocks. In this example, however, the pattern analyzer determines that the data does contain a known pattern. The state follows path 720 to state 702. The encryption manager causes the storage controller to store the data in the number of blocks in unencrypted form. The encryption manager also updates the metadata associated with the number of blocks to indicate that the data in the blocks is unencrypted.

Also from state 706, the operating system may issue a request to implement an encryption policy of “always encrypt” (path 726 to state 708). Alternatively, the operating system may issue a request to decrypt a number of blocks on the storage device and/or edit the encryption policy of the number of blocks to “never encrypt” (path 724 to state 704). The encryption manager decrypts the data stored in the number of blocks and causes the storage controller to store the decrypted data in the number of blocks.

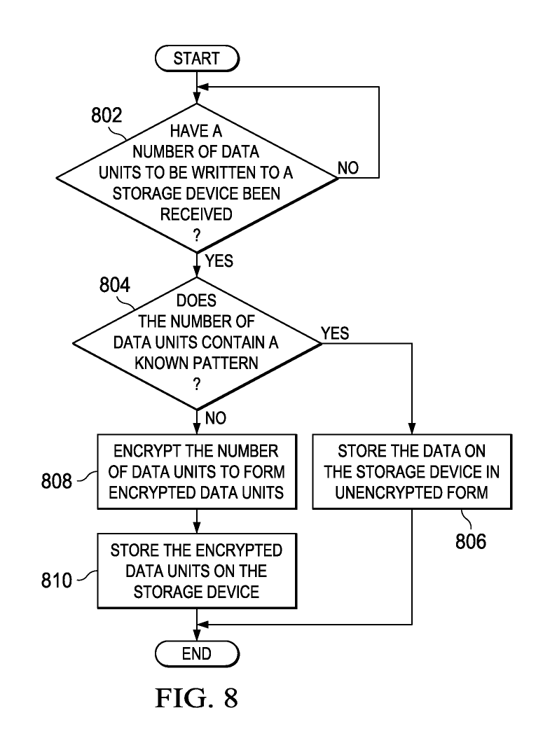

Turning now to FIG. 8, a flowchart of a process for managing encryption of data is depicted in accordance with an illustrative embodiment. The process may be implemented in encryption manager 302 and/or pattern analyzer 304. The process may be executed using data processing system 300. The process may be performed when an encryption policy in metadata associated with the target units on the storage device is a “conditionally encrypt” policy. The storage device may be storage device 312. The metadata may be metadata 314. The target units may be the units that will store a number of data units on the storage device, such as target units 342. The number of data units may be number of data units 306. The encryption policy may be encryption policy 344, and the storage device may be storage device 312 from FIG. 3.

The process begins by determining whether a number of data units to be written to a storage device has been received (step 802). If a number of data units to be written to a storage device has not been received, the process returns to step 802. If a number of data units to be written to a storage device has been received, the process determines whether the number of data units contains a known pattern (step 804). Determining whether the number of data units contains a known pattern may be performed, for example, by comparing the number of data units to a list, table, or database of known patterns in the pattern analyzer. Alternatively, the process may determine that a known pattern is present in some or all of the number of data units if the process has read a particular number of instances of a pattern of data in a particular number of data units. The number of instances and the number of data units may be configured by the user.

If the process determines that the number of data units contains the known pattern, the process stores the number of data units on the storage device in an unencrypted form (step 806). The process terminates thereafter. If the process determines that the data does not contain the known pattern at step 804, the process encrypts the number of data units to form encrypted data units (step 808). The process then stores the encrypted data units on the storage device (step 810). The process terminates thereafter.

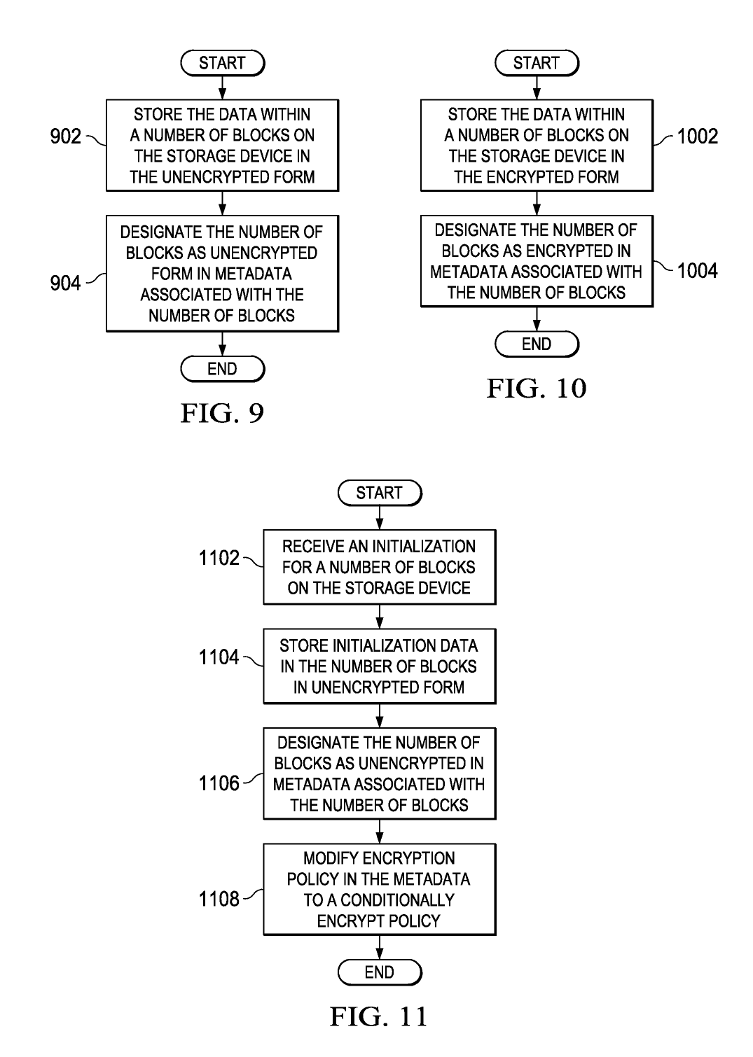

Turning now to FIG. 9, a process for storing a number of data units on the storage device in the unencrypted form is depicted in accordance with an illustrative embodiment. The process implements step 806 from FIG. 8. The process may be implemented in encryption manager 302 and/or pattern analyzer 304. The process may be executed using data processing system 300.

The process begins by storing the data within a number of blocks on the storage device in the unencrypted form (step 902). The process then designates the number of blocks as unencrypted in metadata associated with the number of blocks (step 904). The process terminates thereafter.

Turning now to FIG. 10, a process for storing encrypted data on the storage device is depicted in accordance with an illustrative embodiment. The process in FIG. 10 is an example of one manner in which step 810 from FIG. 8 may be implemented. The process may be implemented in encryption manager 302 and/or pattern analyzer 304. The process may be executed using data processing system 300.

The process begins by storing the data within a number of blocks on the storage device in an encrypted form (step 1002). Examples of encryption algorithms are Data Encryption Standard (DES), Blowfish, International Data Encryption Algorithm (IDEA), and RC4, however, any suitable encryption algorithm may be used. The process then designates the number of blocks as encrypted in the metadata associated with the second number of blocks (step 1004). The process terminates thereafter.

Turning now to FIG. 11, a process for initializing a number of blocks on a storage device is depicted in accordance with an illustrative embodiment. The process may be implemented in encryption manager 302 and/or pattern analyzer 304. The process may be executed using data processing system 300.

The process begins by receiving an initialization request for a number of blocks on the storage device (step 1102). The process then stores initialization data in the number of blocks in the unencrypted form (step 1104). The process then designates the number of blocks as unencrypted in metadata associated with the number of blocks (step 1106). The metadata may be stored on the storage device, another storage device, or any other suitable location. The process then modifies the encryption policy in the metadata to a “conditionally encrypt” policy (step 1108). The “conditionally encrypt” policy may indicate that, in subsequent write operations to the number of blocks, the data to be stored in the number of blocks is to be encrypted unless the data contains a known pattern, such as known pattern 320 in FIG. 3. The process terminates thereafter.

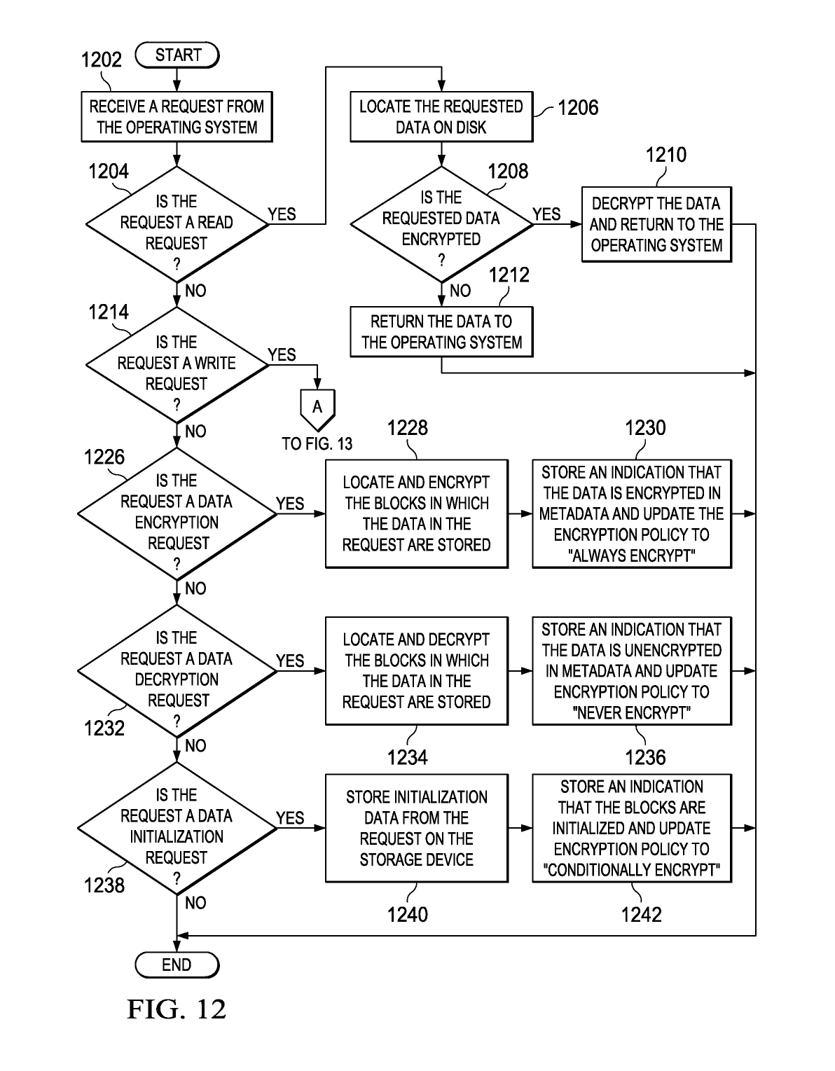

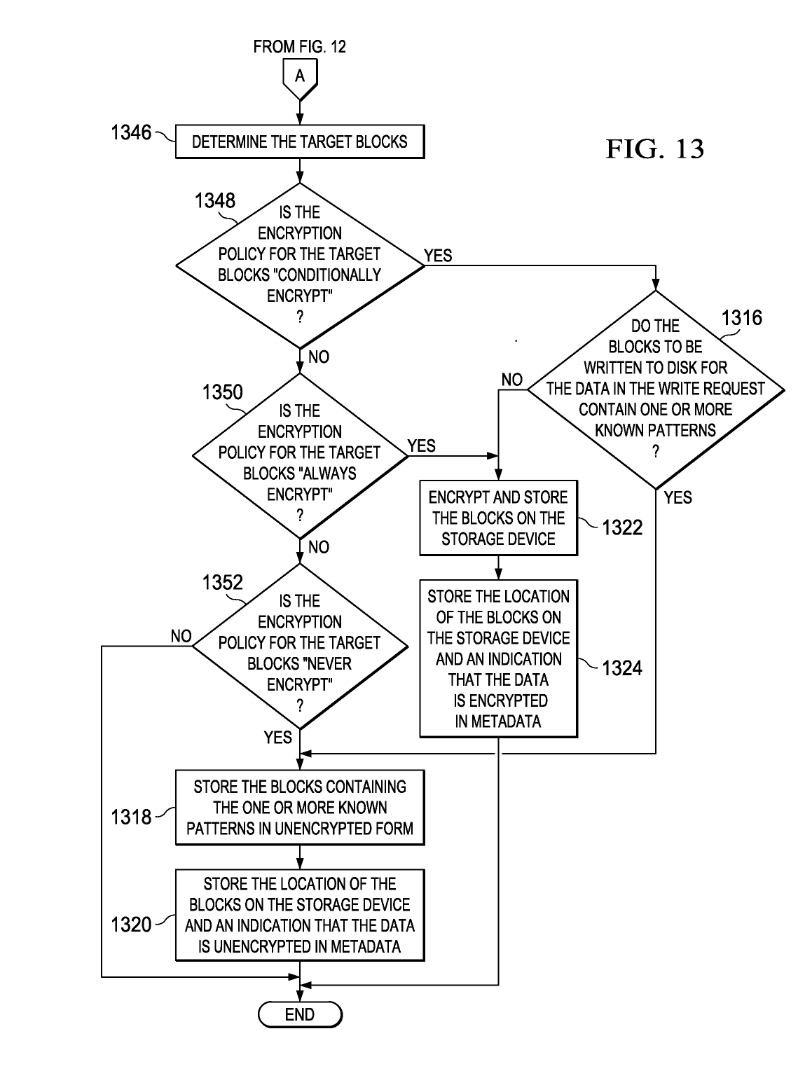

Turning now to FIGS. 12 and 13, a process for handling a request issued by the operating system is depicted in accordance with an illustrative embodiment. The process may be implemented in encryption manager 302 and/or pattern analyzer 304. The process may be executed using data processing system 300.

The process begins by receiving a request from the operating system (step 1202). The process then determines whether the request is a read request (step 1204). If the request is a read request, the process locates the requested data on disk (step 1206). The process then determines whether the requested data is encrypted (step 1208). The process may read metadata for the corresponding location on the storage device to determine whether the requested data is encrypted. If the requested data is encrypted, the process decrypts the data and returns the data to the operating system (step 1210) and terminates. If the requested data is not encrypted at step 1208, the process returns the data to the operating system (step 1212) and terminates.

If the request is not a read request at step 1204, the process determines whether the request is a write request (step 1214). If the process is a write request, the process determines the target blocks (step 1346). The target blocks are the blocks that the storage controller will use to store the blocks on the storage device. The target blocks may be target blocks like target blocks 334 in FIG. 3. The process then determines whether the encryption policy for the target blocks is “conditionally encrypt” (step 1348). If the process determines that the encryption policy for the target blocks is “conditionally encrypt”, the process determines whether the blocks to be written to the storage device for the data in the write request contains one or more known patterns (step 1316). A known pattern may be known pattern 320 in FIG. 3. If the write request contains one or more known patterns, the process stores the blocks containing the one or more known patterns in unencrypted form (step 1318). The process then stores the location of the blocks on the storage device and an indication that the data is unencrypted in metadata (step 1320) and terminates.

If the blocks to be written to the storage device for the data in the write request do not contain one or more known patterns at step 1316, the process encrypts and stores the blocks on the storage device (step 1322). The process then stores the location of the blocks on the storage device and an indication that the data is encrypted in metadata (step 1324) and terminates.

If the process determines that the encryption policy for the target blocks is not “conditionally encrypt” at step 1348, the process determines whether the encryption policy for the target blocks is “always encrypt” (step 1350). If the process determines that the encryption policy for the target blocks is “always encrypt”, then the process proceeds to step 1322. If the process determines that the encryption policy for the target blocks is not “always encrypt” at step 1350, the process determines if the encryption policy for the target blocks is “never encrypt” (step 1352). If the process determines that the encryption policy for the target blocks is “never encrypt”, the process proceeds to step 1318. If the process determines that the encryption policy is not “never encrypt” at step 1352, the process terminates. It will be appreciated that the process may implement additional and/or different encryption policies than the examples used herein. For example, the process may use an “encrypt until an event occurs” encryption policy.

If the process is not a write request at step 1214, the process determines whether the request is a data encryption request (step 1226). If the request is a data encryption request, the process locates and encrypts the block or blocks in which the data in the request is/are stored (step 1228). The process then stores an indication that the data is encrypted in metadata and updates the encryption policy in the metadata to “always encrypt” (step 1230). The process terminates thereafter. The process may replace or delete an existing entry in metadata when storing and/or updating metadata.

If the process is not a data encryption request at step 1226, the process determines whether the request is a data decryption request (step 1232). If the process is a data decryption request, the process locates and decrypts the block or blocks in which the data in the request is/are stored (step 1234). The process then stores an indication that the data is unencrypted in metadata and updates the encryption policy in the metadata to “never encrypt” (step 1236). The process terminates thereafter. The process may replace or delete an existing entry in metadata when storing and/or updating metadata.

If the process is not a data decryption request at step 1232, the process determines whether the request is a data initialization request (step 1238). If the request is a data initialization request, the process stores the initialization data from the request on the storage device (step 1240). The process then stores an indication that the blocks are initialized in metadata and updates the encryption policy in the metadata to an encryption policy of “conditionally encrypt” (step 1242). The process then terminates. If the process is not an initialization request at step 1238, the process terminates. In some illustrative embodiments, the process returns an error to the operating system if the process is not an initialization request at step 1238. However, it will be appreciated that more request types may be implemented by the process. For example, the request may be a request to transmit data over a network, a request to shut down the computer, or any other suitable request.

The illustrative embodiments provide a method, computer program product, and apparatus for managing encryption of data. A determination is made whether the number of data units contains a known pattern responsive to receiving a number of data units to write to a storage device. The number of data units are stored on the storage device in an unencrypted form in response to a determination that the number of data units contains the known pattern. The number of data units are encrypted to form encrypted data units in response to an absence of a determination that the number of data units contains the known pattern. The encrypted data units are then stored on the storage device.

The illustrative embodiments protect encrypted data by detecting patterns of data commonly known to attackers and storing the patterns in an unencrypted form. Data is better protected from unauthorized access as compared with encryption of the known patterns of data on a storage device. Because patterns of data that an attacker is likely to know remain unencrypted, the attacker cannot compare the encrypted form of the patterns of data with an unencrypted form of the same pattern. Thus, the encrypted data on the storage device is more secure against unauthorized access as compared with encryption of known patterns of data on the storage device.

The different illustrative embodiments recognize and take into account a number of different considerations. For example, the different illustrative embodiments recognize that data stored on disks is vulnerable to access by unauthorized parties. In the case of encryption over the entire disk, the data may still be vulnerable to unauthorized access by an attacker. The different illustrative embodiments recognize that attackers may attempt to determine a valid decryption key for encrypted data.

One method used by attackers seeking access to the encrypted data is to analyze the encrypted data for weaknesses that could expose parts of a valid decryption key. An attacker may examine encrypted data on portions of the disk known to be used for operating system data. In this illustrative example, operating system data is data that is stored by the operating system and not generated by the user. Examples of operating system data are cache files, dynamic link libraries, executables, and disk initialization data. Some operating system data may be identical or nearly identical on a number of computers running the operating system. Additionally, the location of some operating system data on the disk may be identical or nearly identical on a number of computers running the operating system.

The different illustrative embodiments recognize that an attacker may assume the approximate content and location of operating system data on the encrypted disk based on the operating system known to be installed on the encrypted disk. The attacker may then compare the encrypted data at the assumed location and the unencrypted operating system data from a number of other computers running the operating system. Once the attacker compares the data, the illustrative embodiments recognize that the attacker may determine a valid decryption key or a portion of a valid decryption key.

Thus, the illustrative embodiments provide a method, apparatus, and computer program product for managing encryption of data. The illustrative embodiments protect encrypted data by detecting patterns of data commonly known to attackers and storing the patterns in an unencrypted form. Attackers cannot combine the unencrypted form of commonly known patterns with the encrypted form of the commonly known patterns of data to determine a valid decryption key or a portion of a valid decryption key because the commonly known patterns of data are not encrypted on the storage device. In addition to detecting the commonly known patterns, the illustrative embodiments allow the operating system to specify whether particular units of data should be stored in unencrypted form or encrypted form. The illustrative embodiments also manage the status of units of data on the storage device by storing a status for each unit in metadata on the storage device.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing encryption of data, the method comprising:
responsive to receiving the data to be written as a number of data units to a storage device, determining whether the number of data units contains a known pattern;
responsive to a determination that the number of data units contains the known pattern, storing the number of data units on the storage device in an unencrypted form;
responsive to an absence of a determination that the number of data units contains the known pattern, encrypting the number of data units to form encrypted data units; and
storing the encrypted data units on the storage device.

2. The method of claim 1, wherein the step of storing the number of data units on the storage device in the unencrypted form further comprises:
storing the data within a number of blocks on the storage device in the unencrypted form; and
designating the number of blocks as unencrypted in metadata associated with the number of blocks.

3. The method of claim 2, wherein the number of blocks is a first number of blocks, and wherein the step of storing the encrypted data on the storage device further comprises:
storing the data within a second number of blocks on the storage device in an encrypted form; and
designating the number of blocks as encrypted in the metadata associated with the second number of blocks.

4. The method of claim 3, wherein the step of determining whether the number of data units contains a known pattern further comprises:
responsive to the number of data units containing data that is not generated by a user, identifying the number of data units as containing the known pattern.

5. The method of claim 1, further comprising:
receiving an initialization request for a number of blocks on the storage device;
responsive to receiving the initialization request, storing initialization data in the number of blocks in the unencrypted form; and
designating the number of blocks as unencrypted in metadata associated with the number of blocks.

6. The method of claim 1, further comprising:
encrypting the number of data units stored on the storage device to form the encrypted data units;
replacing the number of data units stored on the storage device with the encrypted data units;
modifying metadata associated with the number of data units to indicate that the number of data units are stored on the storage device in an encrypted form; and
modifying an encryption policy in the metadata associated with the number of data units to indicate that data written in subsequent write operations to the number of data units is to be in the encrypted form.

7. The method of claim 1, further comprising:
decrypting the encrypted data units stored on the storage device;
replacing the encrypted data units stored on the storage device with the number of data units in the unencrypted form;
modifying metadata associated with the number of data units to indicate that the number of data units are stored on the storage device in the unencrypted form; and
modifying an encryption policy in the metadata associated with the number of data units to indicate that data written in subsequent write operations to the number of data units is to be in the unencrypted form.

8. A computer program product comprising:
a computer readable storage medium;
program code, stored on the computer readable storage medium, responsive to receiving data to be written as a number of data units to a storage device, for determining whether the number of data units contains a known pattern;
program code, stored on the computer readable storage medium, responsive to a determination that the number of data units contains the known pattern, for storing the number of data units on the storage device in an unencrypted form;
program code, stored on the computer readable storage medium, responsive to an absence of a determination that the number of data units contains the known pattern, for encrypting the number of data units to form encrypted data units; and
program code, stored on the computer readable storage medium, for storing the encrypted data units on the storage device.

9. The computer program product of claim 8, wherein the program code for storing the number of data units on the storage device in the unencrypted form further comprises:
program code, stored on the computer readable storage medium, for storing the data within a number of blocks on the storage device in the unencrypted form; and
program code, stored on the computer readable storage medium, for designating the number of blocks as unencrypted in metadata associated with the number of blocks.

10. The computer program product of claim 9, wherein the number of blocks is a first number of blocks, and wherein the program code for storing the encrypted data on the storage device further comprises:
program code, stored on the computer readable storage medium, for storing the data within a second number of blocks on the storage device in an encrypted form; and
program code, stored on the computer readable storage medium, for designating the number of blocks as encrypted in the metadata associated with the second number of blocks.

11. The computer program product of claim 10, wherein the program code for determining whether the number of data units contains a known pattern further comprises:
program code, stored on the computer readable storage medium, responsive to the number of data units containing data that is not generated by a user, for identifying the number of data units as containing the known pattern.

12. The computer program product of claim 8, further comprising:
program code, stored on the computer readable storage medium, for receiving an initialization request for a number of blocks on the storage device;
program code, stored on the computer readable storage medium, responsive to receiving the initialization request, for storing initialization data in the number of blocks in the unencrypted form; and
program code, stored on the computer readable storage medium, for designating the number of blocks as unencrypted in metadata associated with the number of blocks.

13. The computer program product of claim 8, further comprising:
program code, stored on the computer readable storage medium, for encrypting the number of data units stored on the storage device to form the encrypted data units;
program code, stored on the computer readable storage medium, for replacing the number of data units stored on the storage device with the encrypted data units;
program code, stored on the computer readable storage medium, for modifying metadata associated with the number of data units to indicate that the number of data units are stored on the storage device in an encrypted form; and
program code, stored on the computer readable storage medium, for modifying an encryption policy in the metadata associated with the number of data units to indicate that data written in subsequent write operations to the number of data units is to be in the encrypted form.

14. The computer program product of claim 8, further comprising:
program code, stored on the computer readable storage medium, for decrypting the encrypted data units stored on the storage device;
program code, stored on the computer readable storage medium, for replacing the encrypted data units stored on the storage device with the number of data units in the unencrypted form;
program code, stored on the computer readable storage medium, for modifying metadata associated with the number of data units to indicate that the number of data units are stored on the storage device in the unencrypted form; and
program code, stored on the computer readable storage medium, for modifying an encryption policy in the metadata associated with the number of data units to indicate that data written in subsequent write operations to the number of data units is to be in the unencrypted form.

15. An apparatus, the apparatus comprising:
a bus system;
a number of storage devices connected to the bus system, wherein the number of storage devices includes program code; and
a processor unit connected to the bus system, wherein the processor unit executes the program code to receive a request to write data to a storage device, determine whether the data is confidential, encrypt the data to form encrypted data and store the encrypted data on the storage device responsive to determining the data is confidential, and store the data on the storage device in an unencrypted form responsive to determining the data is not confidential.

16. The apparatus of claim 15, wherein the program code to store the number of data units on the storage device in the unencrypted form further comprises:
program code to store the data within a number of blocks on the storage device in the unencrypted form; and
program code to designate the number of blocks as unencrypted in metadata associated with the number of blocks.

17. The apparatus of claim 16, wherein the number of blocks is a first number of blocks, and wherein the program code to store the encrypted data on the storage device further comprises:
program code to store the data within a second number of blocks on the storage device in an encrypted form; and
program code to designate the number of blocks as encrypted in the metadata associated with the second number of blocks.

18. The apparatus of claim 17, wherein the number of data units are received by a storage controller from an operating system using a protocol.

19. The apparatus of claim 17, wherein the program code to determine whether the number of data units contains a known pattern further comprises:
program code to determine that the number of data units contains the known pattern responsive to the number of data units containing data that is not generated by a user.

20. The apparatus of claim 15, wherein the program code further comprises:
program code to receive an initialization request for a number of blocks on the storage device;
program code to store initialization data in the number of blocks in the unencrypted form responsive to receiving the initialization request; and
program code to designate the number of blocks as unencrypted in metadata associated with the number of blocks.
